(19) United States
(12) Patent Application Publication
(10) Pub. No.: US 2020/0256402 A1
(43) Pub. Date: Aug. 13, 2020

(54) Clutch Arrangement

(71) Applicant: ZF FRIEDRICHSHAFEN AG, Friedrichshafen (DE)

(72) Inventors: Christian Schneider, Hammelburg (DE); Alessio Paone, Werneck (DE); Troy Menebroker, Plymouth, MI (US); Richard Wu, Westland, MI (US)

(73) Assignee: ZF Friedrichshafen AG

(21) Appl. No.: 16/686,975

(22) Filed: Nov. 18, 2019

(30) Foreign Application Priority Data
Feb. 8, 2019 (DE) 10 2019 201 646.4

(51) Int. Cl. F16D 25/06; F16D 25/12

(52) U.S. Cl. CPC F16D 25/06; F16D 25/123

(57) ABSTRACT

A clutch arrangement having multiple pressure lines, connected to pressure chambers provided in a clutch housing, a first pressure chamber exerts load on a clutch piston and a second pressure chamber accommodates a clutch element and feeds fluid for cooling the at least one clutch element. The two pressure chambers are separated from one another in a pressure-tight fashion in the region of the clutch piston. The clutch piston and/or a component assigned to the clutch piston is designed such that, when at least one pressure chamber is connected to at least two pressure lines, a flow connection between the two pressure chambers is prevented, whereas, when each pressure chamber is connected to only one pressure line, a flow connection can be produced between the two pressure chambers by virtue of the clutch piston, and/or the component assigned to the clutch piston, being formed with a passage.

### BACKGROUND OF THE INVENTION

### 1. Field of the Invention

The invention relates to a clutch arrangement having a multiplicity of pressure lines connected to at least two pressure chambers provided in a clutch housing, of which a first pressure chamber serves for exerting load on a clutch piston and a second pressure chamber serves for accommodating at least one clutch element of a clutch unit and for feeding fluid for cooling the at least one clutch element, wherein the two pressure chambers are separated from one another in at least substantially pressure-tight fashion in the region of extent of the clutch piston.

### 2. Description of Related Art

A clutch arrangement of said type is known from DE 11 2008 003 612 B4. The clutch arrangement accommodated in the clutch housing of a hydrodynamic torque converter has a radially outer clutch element carrier held on a turbine wheel and a radially inner clutch element carrier supported by a torsional vibration damper. Each clutch element carrier rotationally conjointly holds a multiplicity of clutch elements, which enter into operative connection with one another if, in the first pressure chamber, which extends axially between the radially outer clutch element carrier and the clutch piston, a positive pressure is set in relation to the second pressure chamber, which is situated at the opposite side of the clutch piston and which accommodates inter alia the clutch elements. The clutch arrangement is then engaged. Whereas the first pressure chamber is connected exclusively to one pressure line, which extends with a radial component through a hub that is rotationally conjoint with a transmission input shaft, the second pressure chamber is connected to two pressure lines, each of which utilizes in each case one axial bearing as a passage radially to the outside. Of the two latter pressure lines, one serves for feeding fluid into the clutch housing, and one serves for discharging fluid out of the clutch housing. On its path through the clutch housing, the fluid flows through recesses provided both in the radially outer clutch element carrier and in the radially inner clutch element carrier, and said fluid is thus forced to flow through the clutch elements. This forced flow promotes good absorption of heat by the fluid from the clutch elements, which may have heated up due to frictional slippage. It is however also possible for the operative connection of the clutch elements to one another to be released if the pressure in the first pressure chamber is caused to fall below the pressure prevailing in the second pressure chamber, which occurs because of the corresponding pressure line being relieved of pressure. The clutch arrangement is then disengaged. In the case of such a clutch arrangement, which is referred to among experts as a three-line system, it is thus possible for a fluid exchange to always, take place in the clutch housing irrespective of control processes at the clutch piston.

Alternatively, however, clutch arrangements are also known in which each pressure chamber is assigned only one pressure line. In the case of such clutch arrangements, which are referred to among experts as a two-line system, the two pressure chambers are operatively connected to one another when the clutch arrangement is disengaged, whereas at least substantially no connection exists between the two pressure chambers, and thus between the two pressure lines, when the clutch arrangement is engaged. Then, only a minimal exchange of fluid takes place in the clutch housing across the friction surfaces of clutch elements. Such a clutch arrangement is known from DE 195 27 853 A1. To at least partially compensate for this disadvantage, provision is made for the clutch piston to be formed with a passage, and thus for at least a leakage flow between the two pressure chambers, and thus a limited fluid exchange in the clutch housing, to be permitted. A valve assigned to the passage has the effect that the passage can be flowed through by fluid only in one flow direction.

Owing to different modes of operation in 3-line systems and 2-line systems, and resulting structural differences, the number of possible identical parts is limited. This is reflected in increased manufacturing outlay and thus in higher costs.

### SUMMARY OF THE INVENTION

One aspect of the invention is a clutch arrangement that yields the greatest possible number of identical parts.

According to one aspect of the invention, a clutch arrangement is provided having a multiplicity of pressure lines connected to at least two pressure chambers provided in a clutch housing, of which a first pressure chamber serves for exerting load on a clutch piston and a second pressure chamber serves for accommodating at least one clutch element of a clutch unit and for feeding fluid for cooling the at least one clutch element, wherein the two pressure chambers are separated from one another in at least substantially pressure-tight fashion in the region of extent of the clutch piston.

Here, it is of particular importance that the clutch piston and/or a component assigned to the clutch piston is designed such that, when at least one pressure chamber is connected to at least two pressure lines, a flow connection between the two pressure chambers can be at least substantially prevented, whereas, when each pressure chamber is connected to in each case only one pressure line, a flow connection can be produced between the two pressure chambers by virtue of the clutch piston, and/or the component assigned to the clutch piston, being formed with a passage.

Thus, in the ideal case, 3-line systems and 2-line systems are of structurally identical design and differ from one another only by the form of the clutch piston and/or of a component assigned to the clutch piston, for example a seal for the clutch piston. In the case of a 3-line system, that is to say in the case of at least one pressure chamber being connected to at least two pressure lines, the piston and/or the associated component should be of at least substantially liquid-tight design, whereas, in the case of a 2-line system, that is to say in the case of each pressure chamber being connected to in each case only one pressure line, the clutch piston and/or the component assigned to the clutch piston is equipped with a passage which connects the two pressure chambers to one another.

It is thus generally possible for the clutch piston to be produced with at least one opening. To be able to use this clutch piston both for a two-line system and for a three-line system, provision is made for the clutch piston to be equipped at at least one side with a lining which covers at least the region of extent of the at least one opening and has at least one cut out, wherein the arrangement of the lining relative to the clutch piston is such that, when a passage in the piston or in a component assigned to the piston is undesired, that is to say in the case of a three-line system, the at least one opening in the clutch cover is covered by the corresponding cut out in the trim, whereas, if a passage in the piston or in a component assigned to the piston is desired, that is to say in the case of a two-line system, the at least one opening in the clutch piston is kept free by the corresponding cut out in the trim, by virtue of the cut out being at least substantially aligned with the opening. The lining for the clutch piston is particularly preferably at least substantially of ring-shaped form.

If it is sought to avoid such a trim on the clutch piston, then it is alternatively possible for a component assigned to the clutch piston, such as for example a seal, to be designed such that the different requirements in the case of three-line or two-line systems are met. For this purpose, in the case of use in a 2-line system, said seal should be formed with a recess to ensure a passage which connects the two pressure chambers to one another. To form the recess of the seal, said seal is either equipped at its radial outer side with at least one radial indentation, or else the seal has, on at least one of its axial sides, at least one channel which extends between the radial outer side of the lining and its radial inner side. A fluid passage radially within the clutch piston is thus possible.

### BRIEF DESCRIPTION OF THE DRAWINGS

The subject matter will be discussed in more detail below based on a drawing, in which:

FIG. 1 is a clutch arrangement in a clutch housing with a clutch piston, by means of which two pressure chambers are separated from one another in at least substantially fluid-tight fashion;

FIG. 2 is a clutch arrangement in a clutch housing with a clutch piston, by means of which two pressure chambers are at least substantially fluidically connected to one another by means of a leakage opening;

FIG. 3 is the clutch piston in a plan view with openings as a passage and with a choke plate which closes off said openings;

FIG. 4 is the clutch piston with the openings, which serve as a passage, being opened by cut outs in the trim;

FIG. 5 is the clutch piston with a seal assigned thereto, which seal has a passage for fluid;

FIG. 6 is an enlarged detail of the seal for the clutch piston,

FIG. 7 is the seal with recesses in the form of radial indentations; and

FIG. 8 is the seal with channels as recesses.

### DETAILED DESCRIPTION OF THE PRESENTLY PREFERRED EMBODIMENTS

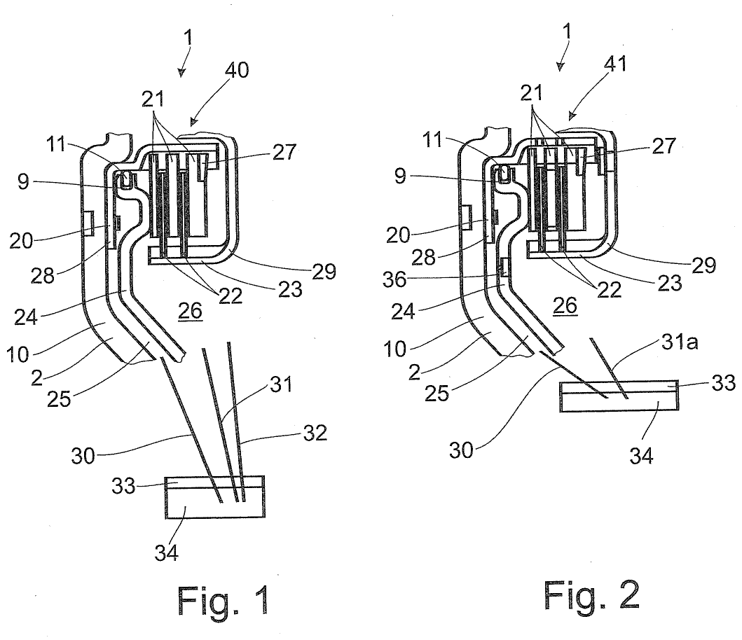

FIG. 1 or 2 illustrates in each case a clutch arrangement 1 provided in a clutch housing 2, which is indicated by a housing cover 10. The clutch arrangement 1 may be part of a hydrodynamic torque converter, of a hydraulic clutch or of a wet-running clutch.

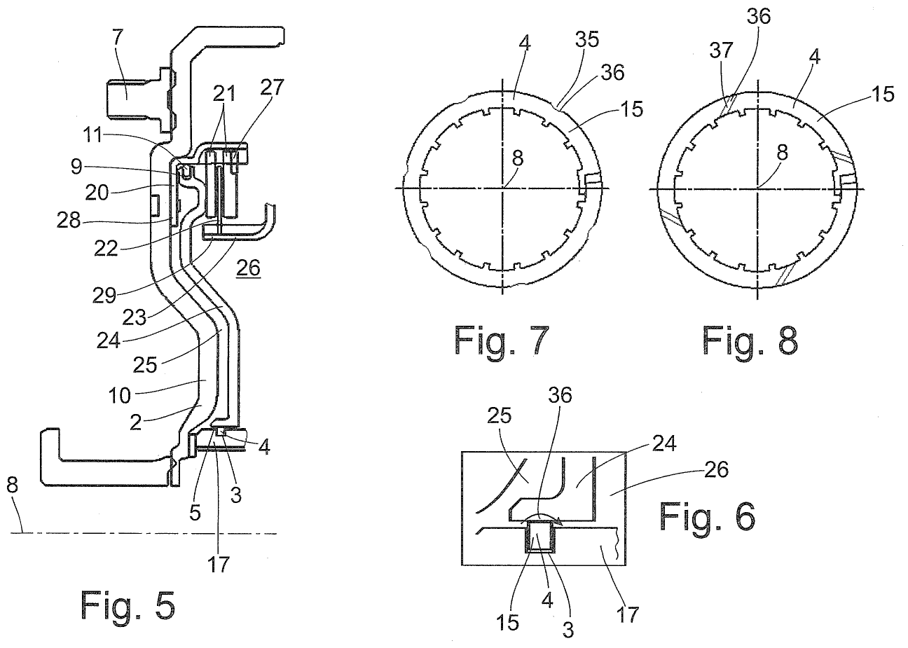

In a manner which is not shown, the clutch housing 2 may be connected rotationally conjointly by attachment elements 7, shown in FIG. 5, to a drive (not shown) such as an internal combustion engine, and said clutch housing performs a rotational movement about a central axis 8 when a rotational movement is introduced by the drive.

The housing cover 10 serves for accommodating a drive-side clutch element carrier 20, which serves as input 28 of the clutch arrangement 1 and for rotationally conjointly holding drive-side clutch elements 21, which are functionally assigned at least one output-side clutch element 22, which engages rotationally conjointly into an output-side clutch element carrier 23. The drive-side clutch element carrier 20 sealingly engages around a clutch piston 24, which is centred in axially displaceable fashion on a hub 17 shown in FIG. 5. To seal off the clutch piston 24 in its radially inner region, a seal 4 is inserted into a depression 3 of the hub 17, which seal comes to bear radially against the radial inner side 5 of the clutch piston 24. Furthermore, the clutch piston 24 has, at its radial outer side, a depression 9 into which a seal 10 is inserted, which seal comes to bear radially against the drive-side clutch element carrier 20.

The clutch piston 24 together with the clutch cover 10 delimits a first pressure chamber 25, whereas a second pressure chamber 26 extends at the opposite side of the clutch piston 24. The supply to the pressure chambers 25, 26 is realized, in a manner which is not shown, from radially inside from a region directly surrounding the central axis 8. If a positive pressure in relation to the second pressure chamber 26 is produced in the first pressure chamber 25, then the clutch piston 24 is displaced in the direction of the clutch elements 21 and 22, to press these together after the drive-side clutch element 21 axially furthest remote from the clutch piston 24 has come to bear against an axial support 27. The clutch arrangement 1 is then engaged, and at least substantially transmits the torque originating from the clutch cover 10 to its output-side clutch element carrier 23, which serves as output 29. Conversely, a positive pressure in the second pressure chamber 26 in relation to the first pressure chamber 25 will have the effect that the clutch piston 24 is displaced in the direction of the housing cover 10, and thus releases the clutch elements 21, 22. The clutch arrangement 3 is then engaged, and transmits at least substantially no torque to its output-side clutch element carrier 23, which serves as output 29.

When a torque provided by the drive is introduced, the torque is, when the clutch arrangement 1 is engaged, conducted from the housing 2 via the drive-side clutch element carrier 20 and the clutch elements 21 and 22 to the output-side clutch element carrier 23, which serves as an output 29 of the clutch device 3.

FIG. 1 illustrates the clutch piston 24 in a three-line system 40. In a three-line system 40, the pressure chamber 25 is connected to a schematically indicated first pressure line 30. The second pressure chamber 26 extending at the opposite side of the clutch piston 24 is connected to two likewise pressure lines 31 and 32, of which a second pressure line, for example the pressure line 31, acts as a fluid inflow, and a third pressure line, for example the pressure line 32, acts as fluid outflow. Via the fluid inflow, in other words via the pressure line 31, fresh fluid originating from a merely schematically illustrated pressure accumulator 34 is then conducted into the clutch housing 2 and flows here from radially inside to the clutch elements 21 and 22, which are cooled by radial throughflow. Subsequently, the fluid flow is, within the clutch housing 2, diverted radially inward, and exits the clutch housing 2 via the pressure line 32, which serves as fluid outflow, to be recirculated to the pressure accumulator 34 again, wherein the flow possibly passes through a fluid cooler 33.

The generation of a positive pressure in the first pressure chamber 25 in relation to the second pressure chamber 26 is likewise realized by the pressure accumulator 34, by the latter building up a higher pressure in the pressure line 30 than in the pressure line 31, which serves as fluid inflow. Owing to this positive pressure, the clutch arrangement 1 is engaged. Conversely, by a dissipation of pressure, generated by the pressure accumulator 34, in the pressure line, the pressure in the first pressure chamber 25 is reduced, and it is thus the clutch arrangement 1 is disengaged. The three-line system thus offers both the possibility of controlling the movement of the clutch piston 24 and that of cooling the clutch elements 21 and 22 of the clutch arrangement, without an exchange of fluid occurring between the two pressure chambers 25 and 26.

In contrast, FIG. 2 is illustrates the clutch piston 24 in a two-line system 41. It is also the case in a two-line system 41 that the pressure chamber 25 is connected to a first pressure line 30. The second pressure chamber 26 extending at the opposite side of the clutch piston 24 is however—in contrast to the three-line system 40—connected to only one pressure line 31a, in this case to the second pressure line 31a. If the pressure in the second pressure chamber 26 is higher than that in the first pressure chamber 25, and the clutch arrangement 1 is thus disengaged, then the pressure line 31a serves as a fluid inflow, wherein said fluid passes to the clutch elements 21 and 22 but, owing to the seal 10 in the radially outer region of the clutch piston 24, not inevitably into the first pressure chamber 25. A passage 36 is therefore required in the clutch piston 36 in order to be able, via said passage 36, to discharge fluid from the second pressure chamber 26 into the first pressure chamber 25 and from there via the first pressure line 30 into the pressure accumulator 34, wherein, in this case, too, the path of the fluid into the pressure accumulator 34 may lead via the fluid cooler 33. By contrast, if the pressure in the first pressure chamber 25 is, via the first pressure line 30, increased beyond the pressure in the second pressure chamber 26, and the clutch arrangement 1 is engaged, then the fluid can likewise pass only via the passage 36 in the clutch piston 24 from the first pressure chamber 25 into the second pressure chamber 26, and from there via the second pressure line 31a into the pressure accumulator 34, possibly via the fluid cooler 33. Accordingly, in the two-line system 41, the passage 36 in the clutch piston 24 is imperatively necessary to introduce fresh fluid from the pressure regulator 34 into one of the pressure chambers 25 or 26, and thus make said fresh fluid available for the cooling of the clutch elements 21 and 22.

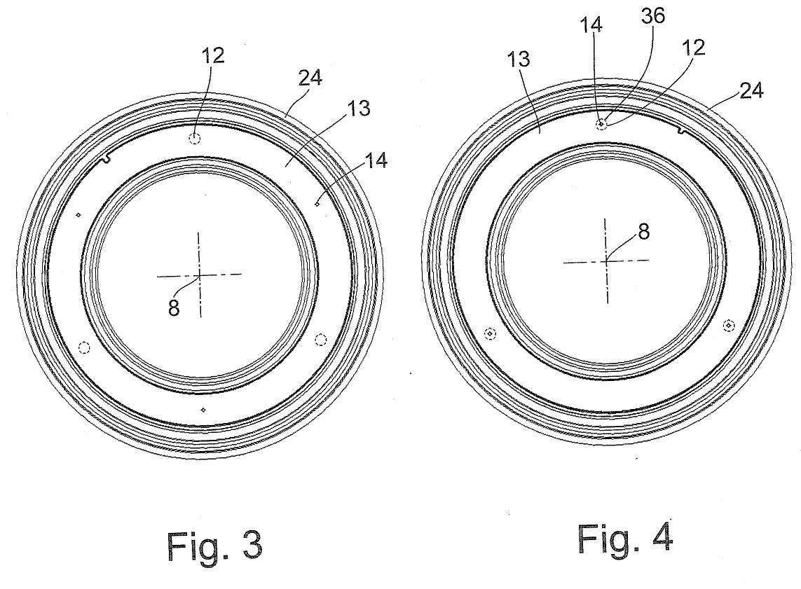

Structurally, in the embodiments as per FIGS. 1 and 2, the clutch arrangements 1 differ merely in that a three-line system 40 should be formed without a passage, for example in the clutch piston 24, whereas a two-line system 41 should have a passage 36. To avoid the need to use a differently designed clutch piston 24 for a three-line system 40 than for a two-line system 41, corresponding solutions are specified in FIGS. 3, 4 and 6 to 8.

In FIGS. 3 and 4, in the radially outer region of the clutch piston 24, there are provided openings 12 each with uniform circumferential spacings to one another. For the radial region in which the openings 12 are provided in the clutch piston 24, a trim 13 is provided which is fastened, for example by adhesive bonding, riveting or welding, to one axial side of the clutch piston 24. The trim 13 preferably has several cut outs 14 corresponding to the number of openings 12 in the clutch piston 24, which cut outs are arranged not only with in each case equal circumferential spacings to one another but furthermore with the same circumferential spacings of the openings 12 of the clutch piston 24. Furthermore, the cut outs 14 should be provided in a radial region of the trim 13 in which they are situated at the same radial height in relation to the central axis 8 as the openings 12 in the clutch piston 24. For the use of the clutch piston 24 in a two-line system 41 as shown in FIG. 4, the cut outs 14 are, by corresponding angular orientation of the trim 13 relative to the clutch piston 24, positioned in each case at a location in which the cut outs 14 of the trim 13 are at least substantially aligned with the openings 12 of the clutch piston 24, and thus the openings 12 are open for the passage of fluid between the two pressure chambers 25 and 26. A passage 36 thus exists between the two pressure chambers 25 and 26. In the case of the use of the clutch piston 24 in a three-line system 40 as shown in FIG. 3, the cut outs 14 are, by corresponding angular orientation of the trim 13 relative to the clutch piston 24, positioned in each case at a location in which the cut outs 14 of the trim 13 are not aligned with the openings 12 of the clutch piston 24, such that the openings 12 are closed off by the trim 13. There is thus no passage between the two pressure chambers 25 and 26.

FIGS. 6 to 8 show a solution in which the passage 36 between the two pressure chambers 25 and 26 is realized by a component 15 assigned to the clutch piston 24, such as for example the seal 4 arranged in the depression 3 of the hub 17. For this purpose, the seal 4 illustrated in principle in FIG. 6 has, as per FIG. 7, radial indentations 35 on its radial outer side, which radial indentations are provided with predetermined circumferential spacings to one another and can be utilized as a passage 36. In FIG. 8, the seal 4 is equipped, on at least one of its axial sides, with channels 37 which extend between the radial outer side of the seal 4 and the radial inner side thereof. Said channels 37 can also be utilized as a passage 36.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A clutch arrangement comprising:
a clutch housing;
a clutch piston;
at least two pressure chambers provided in the clutch housing, a first pressure chamber of the at least two pressure chambers configured to exert load on the clutch piston and a second pressure chamber of the at least two pressure chambers configured to accommodate at least one clutch element and for feeding a fluid for cooling the at least one clutch element, wherein the at least two pressure chambers are separated from one another in at least a substantially pressure-tight fashion in a region of extent of the clutch piston;
a multiplicity of pressure lines, connected to the at least two pressure chambers provided in the clutch housing;
wherein at least one of the clutch piston and a component assigned to the clutch piston is configured such that:
when at least one pressure chamber is connected to at least two pressure lines of the multiplicity of pressure lines, a flow connection between the two pressure chambers is at least substantially prevented, and
when each pressure chamber is connected to in each case only one pressure line of the multiplicity of pressure lines, a flow connection is produced between the two pressure chambers by the at least one of the clutch piston and the component assigned to the clutch piston being formed with a passage.

2. The clutch arrangement according to claim 1,
wherein the clutch piston has at least one opening and is equipped at at least one side with a trim which covers at least the region of extent of the at least one opening and which has at least one cut out,
wherein the arrangement of the trim relative to the clutch piston is configured to prevent formation of a passage so that the at least one opening is at least substantially covered by the cut out,
wherein to form a passage, the at least one opening is at least substantially aligned with a corresponding cut out of the trim.

3. The clutch arrangement according to claim 2, wherein the trim for the clutch piston is at least substantially ring-shaped.

4. The clutch arrangement according to claim 1, wherein the component assigned to the clutch piston is a seal, which, to form a passage, is equipped with a recess which connects the two pressure chambers to one another.

5. The clutch arrangement according to claim 4, wherein the seal for the clutch piston is equipped, on its radial outer side, with at least one radial indentation which acts as a recess.

6. The clutch arrangement according to claim 5, wherein the seal for the clutch piston has, on at least one of its axial sides, at least one channel which acts as a recess and which extends between a radial outer side of the seal and a radial inner side of the seal.
